(19) United States
(12) Patent Application Publication
(10) Pub. No.: US 2008/0232863 A1
(43) Pub. Date: Sep. 25, 2008

(54) Image forming apparatus

(75) Inventor: Katsushi Saiki, Osaka (JP)

Correspondence Address: SMITH, GAMBRELL & RUSSELL, 1130 CONNECTICUT AVENUE, N.W., SUITE 1130, WASHINGTON, DC, 20036, US

(73) Assignee: KYOCERA MITA CORPORATION

(21) Appl. No.: 12/076,113

(22) Filed: Mar. 13, 2008

(30) Foreign Application Priority Data
Mar. 20, 2007 (JP) 2007-072328

(51) Int. Cl. G03G 15/08

(52) U.S. Cl. 399/285

(57) ABSTRACT

In an image forming apparatus 1 including a photoconductive drum 31 on which an electrostatic latent image is formed and a developer carrier that is allowed to carry a developer thereon by a developing bias voltage applied thereto composed of a DC component and an AC component and that is arranged in the vicinity of the photoconductive drum 31, the image forming apparatus 1 visualizing the electrostatic latent image using the developer carried on the developer carrier, a high-frequency region A with respect to which image forming is performed with the frequency of the AC component of the developing bias voltage increased and a low-frequency region B with respect to which image forming is performed with the frequency of the AC component of the developing bias voltage decreased are formed in an image to be formed on recording paper.

This application is based on Japanese Patent Application No. 2007-072328 filed on Mar. 20, 2007, the contents of which are hereby incorporated by reference.

### BACKGROUND OF THE INVENTION

1. Field of the Invention

The present invention relates to an image forming apparatus in which an electrostatic latent image is visualized with a developer carried on a developer carrier.

2. Description of Related Art

A conventional image forming apparatus is disclosed in JP-A-H11-272048. This image forming apparatus has a photoconductive drum on which an electrostatic latent image is formed based on image data. A developing device having a developer carrier carrying a developer thereon is arranged so as to face the photoconductive drum. The developer is so-called mono-component nonmagnetic toner, which contains no magnetic carrier. A developing bias voltage composed of a DC component and an AC component is applied to the developer carrier, and this allows the developer carrier to carry the developer.

The developer carrier is arranged adjacent to the photoconductive drum to supply the developer to an electrostatic latent image formed on the photoconductive drum so as to visualize the electrostatic latent image as a toner image. The toner image is transferred to recording paper and an image is formed on the recording paper.

When a predetermined period of time has passed after previous image forming, a developing bias voltage the frequency of whose AC component is high is applied to the developer carrier. If the developer is left on the developer carrier for a long time, the amount of electric charge of the developer becomes unstable, and this causes concentration variation in the toner image in the circumferential direction of the photoconductive drum. This results in concentration variation in an image formed on the recording paper. By increasing the frequency of the AC component of the developing bias voltage, the amount of electric charge of the developer can be stabilized, and this makes it possible to prevent concentration variation occurring in the image.

However, according to the conventional image forming apparatus described above, when the frequency of the AC component of the developing bias voltage is increased, electronic components such as a transformer and an FET provided for applying a high-frequency voltage generate more heat. Thus, it is necessary to use an electronic component having a high rated frequency or to cool down by use of a heat sink or a cooling fan in order to prevent reliability degradation of each electronic component. This results in inconveniences of size increase and cost increase of the image forming apparatus.

### SUMMARY OF THE INVENTION

An object of the present invention is to provide an image forming apparatus that can prevent concentration variation occurring in an image and reduce heat generation without increase in cost or size.

To achieve the above object, according to the present invention, an image forming apparatus includes: a photoconductive drum on which an electrostatic latent image is formed; and a developer carrier that is arranged adjacent to the photoconductive drum, that is allowed, by a developing bias voltage composed of a DC component and an AC component applied thereto, to carry a developer thereon with which the electrostatic latent image is visualized to be formed as an image on recording paper, and that forms, in an image on the recording paper, a high-frequency region where image forming is performed with a frequency of the AC component of the bias voltage increased and a low-frequency region where image forming is performed with the frequency of the AC component of the bias voltage decreased according to image data.

In this structure, laser light is applied to the electrically charged photoconductive drum according to the image data, and thereby an electrostatic latent image is formed. The developer carrier is allowed to carry the developer thereon by the developing bias voltage applied thereto, and the developer is supplied to the photoconductive drum. Thus, the latent image is visualized on the photoconductive drum and the visualized image is transferred onto the recording paper. The developing bias voltage is composed of the DC component and the AC component, and the frequency of the AC component is varied according to the image data. Thus, the high frequency region where image forming is performed with the frequency of the AC component increased and the low frequency region where image forming is performed with the frequency of the AC component decreased are formed in the image on the recording paper.

According to the present invention, the frequency of the AC component of the developing bias voltage applied to the developer carrier is varied according to the image data. Thus, it is possible, in the case of an image where concentration variation is visually noticeable, to increase the frequency of the AC component of the developing bias voltage so as to stabilize the charge amount of the developer, and thereby to prevent concentration variation. In addition, in the case of an image where concentration variation is hardly noticeable visually, the amount of heat generated by an electronic component for applying a high-frequency voltage can be reduced by reducing the frequency of the AC component of the developing bias voltage. This helps reduce the total amount of heat generated by electronic components in image forming operation. As a result, the need to use an electronic component having a high rated frequency is eliminated, and the need to provide cooling means such as a heat sink and a fan is also eliminated. Thus, concentration variation occurring in an image can be prevented without cost increase or size increase.

According to the present invention, it is preferable that the image forming apparatus described above further include a plurality of image quality modes of different degrees of definition. Here, in a high-definition image quality mode, the high-frequency region and the low-frequency region are formed, and the frequency of the AC component of the developing bias voltage in a low-definition image quality mode is decreased regardless of the image data. With this structure, when the low-definition image quality mode is selected, image forming is performed with the frequency of the AC component of the developing bias voltage decreased; when the high-definition image quality mode is selected, the frequency of the AC component of the developing bias voltage is varied according to the image data.

This makes it possible to reduce the amount of heat generation in the low-definition image quality mode, in which the image quality is not required to be high. Thus, concentration variation can be prevented from occurring in the high-definition image quality mode, and also the total amount of heat generation can be further reduced.

According to the present invention, it is preferable that, in the image forming apparatus described above, an image in the high-frequency region be a non-character image and that an image in the low-frequency region be a character image. With this structure, when the image data is non-character image data, image forming is performed with the frequency of the AC component of the developing bias voltage set high. When the image data is character image data, image forming is performed with the frequency of the AC component of the developing bias voltage set low.

This makes it possible to prevent concentration variation occurring in the image. In addition, since the frequency of the AC component of the developing bias voltage applied to a character region, where concentration variation is hardly noticeable visually, is set low, the amount of heat generation can be reduced.

According to the present invention, in the image forming apparatus described above, it is preferable that an image in the high-frequency region be a non-character image that includes a halftone, and that an image in the low-frequency region be a non-character image that includes no halftone. With this structure, when the image data is non-character image data including a halftone, image forming is performed with the frequency of the AC component of the developing bias voltage set high. When the image data is non-character image data including no halftone, image forming is performed with the frequency of the AC component of the developing bias voltage set low.

This makes it possible to prevent concentration variation occurring in a non-character image including a halftone. In addition, since the frequency of the AC component of the developing bias voltage applied to a region of a non-character image including no halftone, where concentration variation is hardly noticeable visually, is decreased, the amount of heat generation can be reduced.

According to the present invention, in the image forming apparatus described above, it is preferable that an image in the high-frequency region be a color image, and that an image in the low-frequency region be a monochrome image. With this structure, when the image data is color image data, image forming is performed with the frequency of the AC component of the developing bias voltage set high. When the image data is monochrome image data, image forming is performed with the frequency of the AC component of the developing bias voltage set low.

This makes it possible to prevent concentration variation occurring in a color image. In addition, since the frequency of the AC component of the developing bias voltage applied to a monochrome image region, where concentration variation is hardly noticeable visually, is decreased, the amount of heat generation can be reduced.

According to the present invention, in the image forming apparatus described above, it is preferable that the image data be recognized such that each of divided ranges into which an image forming range is divided is recognized one by one, and that each divided range be variable between the high-frequency region and the low-frequency region according to a recognition result. With this structure, the type and attribute of an image in each of the divided ranges into which the image forming range is divided are recognized based on the image data, and the frequency of the AC component of the developing bias voltage is switched for each of the divided ranges on a one-by-one basis. A divided range is one of the pages constituting an image forming range, one of a plurality of regions into which a page is divided, and the like.

This makes it easy, in forming an image, to switch between the high frequency region and the low frequency region according to whether or not concentration variation is visually noticeable in the image.

According to the present invention, in the image forming apparatus described above, it is preferable that density in an image (hereinafter, image density) be high in the high-frequency region and low in the low-frequency region. With this structure, in image forming, when image density is high in a divided range, image forming is performed with the frequency of the AC component of the developing bias voltage applied to the divided range set high; when image density is low in a divided range, image forming is performed with the frequency of the AC component of the developing bias voltage applied to the divided range set low.

This makes it possible to prevent concentration variation occurring in a divided range where density is high. In addition, since the frequency of the AC component of the developing bias voltage applied to a divided range of low image density, where concentration variation is hardly noticeable visually, is decreased, the amount of heat generation can be reduced.

According to the present invention, in the image forming apparatus described above, it is preferable that an image in the high-frequency region include a non-character image and that an image in the low-frequency region include no non-character image. With this structure, when an image in a divided range includes a non-character image, image forming is performed with the frequency of the AC component of the developing bias voltage set high; when an image in a divided range includes no non-character image, image forming is performed with the frequency of the AC component of the developing bias voltage set low.

This makes it possible to prevent concentration variation occurring in a divided range that includes a non-character image. In addition, since the frequency of the AC component of the developing bias voltage applied to a divided range including no non-character image, where concentration variation is hardly noticeable visually, is decreased, the amount of heat generation can be reduced.

According to the present invention, in the image forming apparatus described above, it is preferable that an image in the high-frequency region include a halftone non-character image and an image in the low-frequency region include no non-character halftone image. With this structure, when an image in a divided range includes a halftone non-character image, image forming is performed with the frequency of the AC component of the developing bias voltage applied to the divided range set high; when an image in a divided range includes no halftone non-character image, image forming is performed with the frequency of the AC component of the developing bias voltage applied to the divided range set low.

This makes it possible to prevent concentration variation occurring in a divided range that includes a halftone non-character image. In addition, since the frequency of the AC component of the developing bias voltage applied to a divided range including no halftone non-character image, where concentration variation is hardly noticeable visually, is decreased, the amount of heat generation can be reduced.

According to the present invention, in the image forming apparatus described above, it is preferable that an image in the high-frequency region include a color image and an image in the low-frequency region include no color image. With this structure, when an image in a divided range includes a color image, image forming is performed with the frequency of the AC component of the developing bias voltage applied to the divided range set high. When an image in a divided range includes no color image, image forming is performed with the frequency of the AC component of the developing bias voltage applied to the divided range set low.

This makes it possible to prevent concentration variation occurring in a divided range that includes a color image. In addition, since the frequency of the AC component of the developing bias voltage applied to a divided range including no color image, where concentration variation is hardly noticeable visually, is decreased, the amount of heat generation can be reduced.

According to the present invention, in the image forming apparatus described above, it is preferable that the high-frequency region and the low-frequency region can be set by a user. This makes it possible to securely prevent concentration variation occurring in a divided range as the user desires. Thus, the image forming apparatus can be more user-friendly.

According to the present invention, in the image forming apparatus described above, it is preferable that the developer be mono-component nonmagnetic toner.

### BRIEF DESCRIPTION OF THE DRAWINGS

FIG. 1 is a front view schematically showing the structure of an image forming apparatus of a first embodiment of the present invention;

FIG. 2 is a detailed front view showing an image forming section of the image forming apparatus of the first embodiment of the present invention;

FIG. 3 is a block diagram showing the drive system of a developing device of the image forming apparatus of the first embodiment of the present invention;

FIG. 4 is a flow chart showing an operation of an image forming unit of the image forming apparatus of the first embodiment of the present invention;

FIG. 5 is a plan view showing a sheet of recording paper on which an image is formed by the image forming apparatus of the first embodiment of the present invention; and

FIG. 6 is a flow chart showing an operation of an image forming unit of an image forming apparatus of a second embodiment of the present information.

### DETAILED DESCRIPTION OF PREFERRED EMBODIMENTS

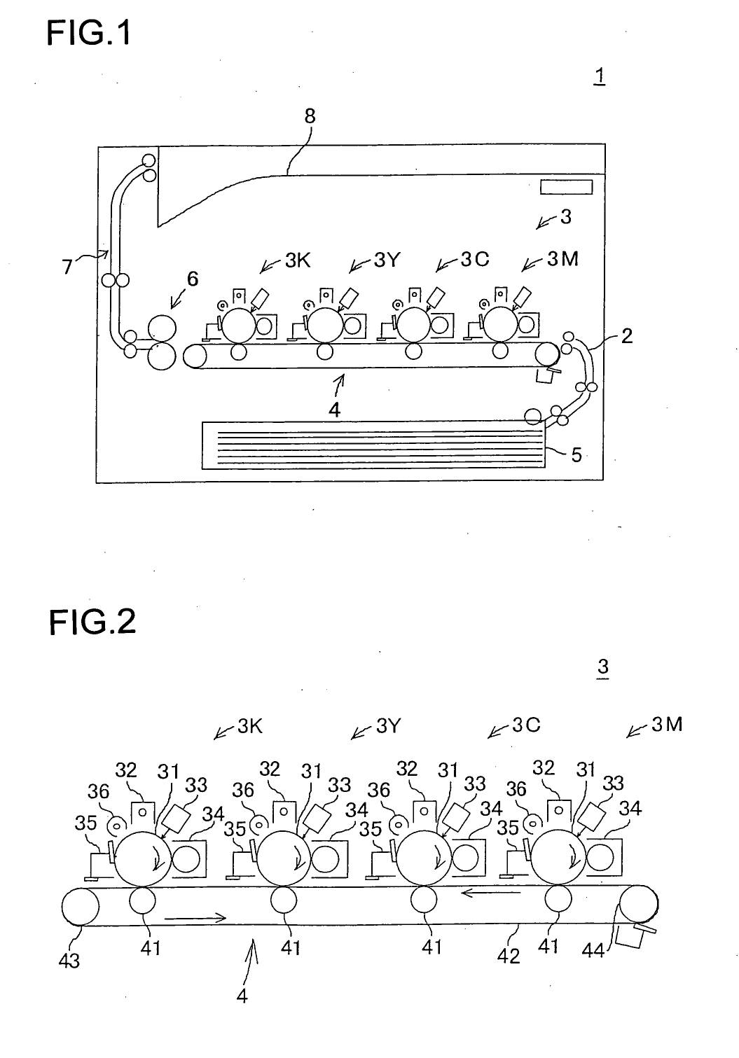

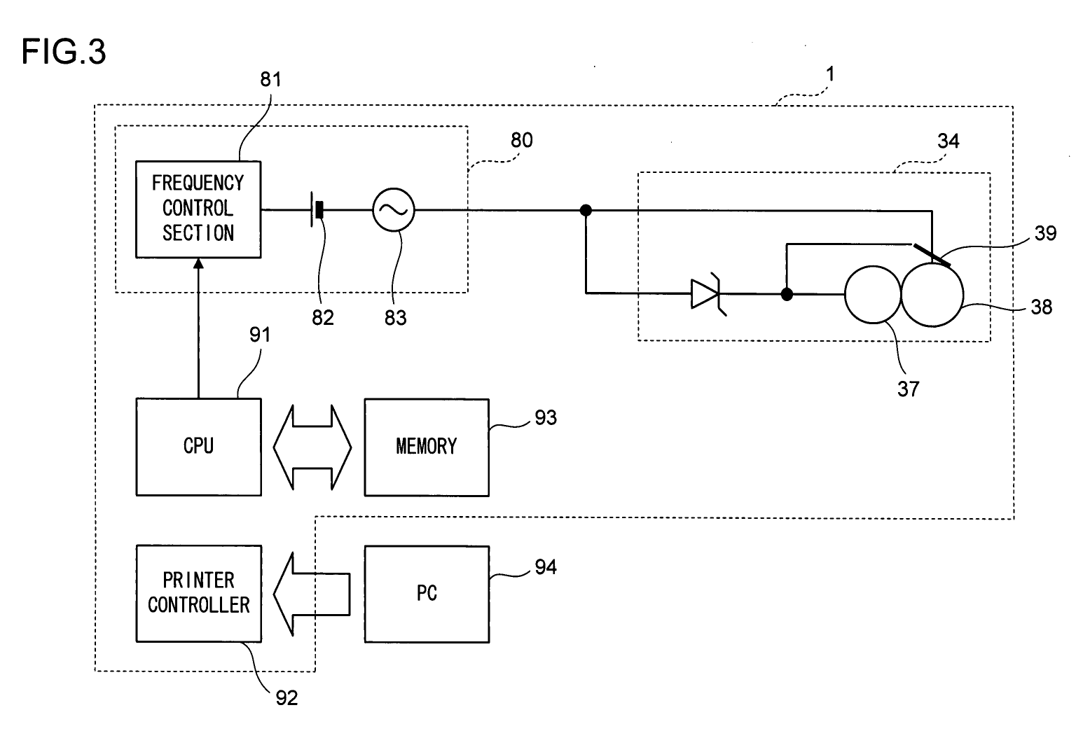

Description will be given below of an embodiment of the present invention with reference to the accompanied figures. FIG. 1 is a front view schematically showing the structure of an image forming apparatus of a first embodiment of the present invention. The image forming apparatus 1 is a printer that is connected to a personal computer 94 (see FIG. 3), and forms an image according to an instruction given by the personal computer 94.

At the bottom of the image forming apparatus 1, a paper feeding section 5 is provided. Above the paper feeding section 5, there is provided a transport section 4 having a rotating endless belt 42. The transport section 4 is connected to the paper feeding section 5 via a first transport passage 2, and transports recording paper fed from the paper feeding section 5.

Above the transport section 4, an image forming section 3 is provided. The image forming section 3 is provided with image forming units 3M, 3C, 3Y, and 3K that correspond to four colors of magenta, cyan, yellow, and black, respectively. Toner images formed by the image forming units 3M, 3C, 3Y, and 3K are transferred onto the recording paper transported by the transport section 4 so as to be superposed on one another.

At the rear portion of the image forming section 3, a fixing device 6 is arranged. The fixing device 6 applies heat and fixes the toner images formed on the recording paper by the image forming section 3. Thus, a color image is formed on the recording paper. A monochrome image is formed by transferring only the toner image formed by the image forming unit 3K onto the recording paper. At the top of the image forming apparatus 1, a paper ejection tray 8 is formed. The paper ejection tray 8 is connected to the fixing device 6 via a second transport passage 7, and the recording paper on which the image is formed is ejected to be put thereon.

FIG. 2 is a front view showing the image forming section 3 and the transport section 4. The endless belt 42 of the transport section 4 is arranged between and around support rollers 43 and 44 under tension, and is rotated by being driven by the support roller 43 in the direction indicated by the arrow in the figure. A transfer device 41 is provided in plurality, and each faces a corresponding photoconductive drum 31, which will be described later, with the endless belt 42 laid therebetween. The transfer device 41 is polarized so as to be opposite in polarity to toner that is electrically charged on the surface of the photoconductive drum 31.

The image forming units 3M, 3C, 3Y, and 3K of the image forming section 3 have the same structure, and are arranged in tandem so as to be in contact with the endless belt 42. The image forming units 3M, 3C, 3Y, and 3K may be arranged in a different order. The image forming units 3M, 3C, 3Y, and 3K each have the corresponding photoconductive drum 31. Around each of the photoconductive drum 31, a charger 32, an optical scanning unit 33, a developing device 34, a cleaner 35, and a discharger 36 are arranged clockwise in the figure. The photoconductive drum 31 comes in contact with the endless belt 42 between the developing device 34 and the cleaner 35.

The photoconductive drum 31 rotates clockwise (in the direction indicated by the arrow) in the figure, and the charger 32 uniformly charges the photoconductive drum 31. The optical scanning unit 33 emits laser light, and removes charge from the surface of the photoconductive drum 31 according to image data fed to the image forming apparatus 1. Thus, an electrostatic latent image is formed on the surface of the photoconductive drum 31.

The developing device 34 supplies toner serving as a developer to the electrostatic latent image formed on the photoconductive drum 31 so as to visualize the electrostatic latent image as a toner image. This toner image is transferred onto the recording paper transported by the transport section 4. The cleaner 35 is composed of parts such as a blade that is arranged to be in contact with the photoconductive drum 31, and removes residual toner left without being transferred onto the recording paper. The discharger 36 removes electric charge from the surface of the photoconductive drum 31.

FIG. 3 is a block diagram showing the drive system of the developing device 34. The image forming apparatus 1 is provided with a printer controller 92 that receives image data from the personal computer 94, and gives, according to the image data, an instruction to drive each section. A CPU 91 that is connected to the printer controller 92, based on an instruction from the printer controller 92, performs calculation for each section to be driven. A memory 93 that is connected to the CPU 91 stores therein an operation program of the image forming apparatus 1, and performs temporary storage of a calculation result by the CPU 91.

The developing device 34 is provided with a feeding roller 37 and a developing roller 38. The feeding roller 37 and the developing roller 38 are immersed in the toner serving as the developer, and the developing roller 38 is placed close to the photoconductive drum 31. The toner is so-called mono-component nonmagnetic toner, which includes no magnetic carrier. The feeding roller 37 and the developing roller 38 rotate, thereby feeding toner to the surface of the developing roller 38. The developing roller 38 is allowed to carry toner thereon by a developing bias voltage applied thereto by a high-voltage power supply 80, and supplies the toner to the photoconductive drum 31. Thus, the developing roller 38 is a developer carrier for carrying a developer thereon that is mono-component nonmagnetic toner.

A control blade 39 is provided for forming on the developing roller 38 a thin layer of the toner supplied to the developing roller 38 from the feeding roller 37. A DC bias difference of approximately 100 V is set between the developing roller 38 and the control blade 39 so as to stabilize the thickness of the thin layer and the amount of electric charge of the toner.

The high-voltage power supply 80 is connected to the CPU 91, and is provided with a DC power supply 82 and an AC power supply 83. The DC power supply 82 and the AC power supply 83 apply a developing bias voltage composed of a DC component and an AC component to the developing roller 38. A frequency control section 81 is provided for varying the frequency of the AC component of the developing bias voltage from the AC power supply 83.

In the image forming apparatus 1 structured as described above, when an instruction to start printing is given by the personal computer 94, image data is sent to the image forming apparatus 1. The support roller 43 is driven to rotate the endless belt 42, and the recording paper fed from the paper feeding section 5 is led to the transport section 4 by the first transport passage 2.

The photoconductive drum 31, provided one in each of the image forming units 3M, 3C, 3Y, and 3K, rotates clockwise in FIG. 3. When the photoconductive drum 31 starts to rotate, the surface thereof is uniformly charged by the charger 32. Then, laser light is applied to the photoconductive drum 31 by the optical scanning unit 33 so as to remove electric charge either corresponding to an image part including an image to be formed on the recording paper or corresponding to a non-image part including no image. Thus, an electrostatic latent image is formed on the surface of the photoconductive drum 31. The electrostatic latent image on the photoconductive drum 31 is supplied with toner by the developer 34 so as to be visualized as a toner image.

When the photoconductive drum 31 further rotates until the toner image faces the transfer device 41, a voltage that is opposite in polarity to the toner is applied to the transfer device 41. Thus, the toner image formed on the surface of the photoconductive drum 31 is transferred to the recording paper transported by the transport section 4. Residual toner left on the surface of the photoconductive drum 31 without being transferred is removed from the surface of the photoconductive drum 31 by the cleaner 35. Then, the surface of the photoconductive drum 31 is discharged by the discharger 36.

The image forming units 3M, 3C, 3Y, and 3K are driven in turn at a predetermined timing, and toner images of different colors including black are superposed on one another on the recording paper transported by the transport section 4.

The recording paper on which the toner images are transferred is led to the fixing device 6 by the transport section 4. At the fixing device 6, the toner images are fixed on the recording paper. The recording paper on which an image is fixed is transported along the second transport passage 7 to be ejected onto the paper ejection tray 8.

A monochrome image can be formed by stopping the operation of the image forming units 3M, 3C, and 3Y and transferring only the toner image of the image forming unit 3K onto the recording paper.

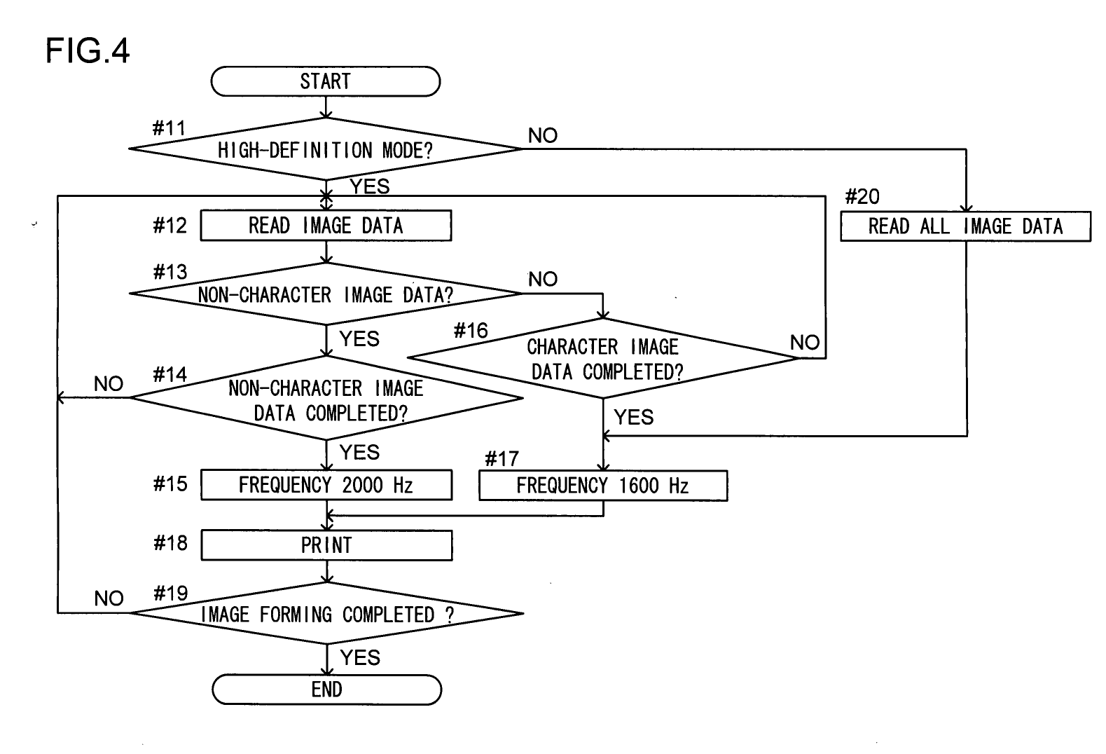

FIG. 4 is a flow chart showing in detail how the image forming units 3M, 3C, 3Y, and 3K operate when printing is performed. The image forming apparatus 1 can perform image forming in a plurality of image quality modes of different degrees of definition. In printing, an image quality mode is specified by the personal computer 94. At step #11, it is checked whether or not the printing is to be performed in a high-definition image quality mode (hereinafter referred to as “high-definition mode”). When the printing is found to be performed in a low-definition image quality mode (hereinafter referred to as “low-definition mode”), the process proceeds to step #20.

In the case of printing in the high-definition mode, the process proceeds to step #12, where image data fed from the personal computer 94 is read. At step #13, it is checked whether or not the image data that has started to be read is non-character image data. When the image data is found to be non-character image data, the process proceeds to step #14, and steps #12 to #14 are repeatedly performed until the reading of the non-character image data is completed. When the reading of the non-character image data is completed, the process proceeds to step #15, where the frequency of the AC component of the developing bias voltage applied to the developing roller 38 is set to, for example, 2000 Hz.

When the image data is found to be character image data at step #13, the process proceeds to step #16, and steps #12, #13, and #16 are repeatedly performed until the reading of the character image data is completed. When the reading of the character image data is completed, the process proceeds to step #17, where the frequency of the AC component of the developing bias voltage applied to the developing roller 38 is set to, for example, 1600 Hz.

At step #18, development is performed according to the set frequency of the AC component of the developing bias voltage, and a non-character image is printed according to the non-character image data, or a character is printed according to the character image data. At step #19, it is checked whether or not the forming of all the images requested by the personal computer 94 has been completed. When a character image needs to be formed after a non-character image is formed, or when a non-character image needs to be formed after a character image is formed, the process returns to step #12, and steps #12 to #19 are repeatedly performed. When all the image forming is found to have been completed, the processing by the image forming units 3M, 3C, 3Y, and 3K is stopped.

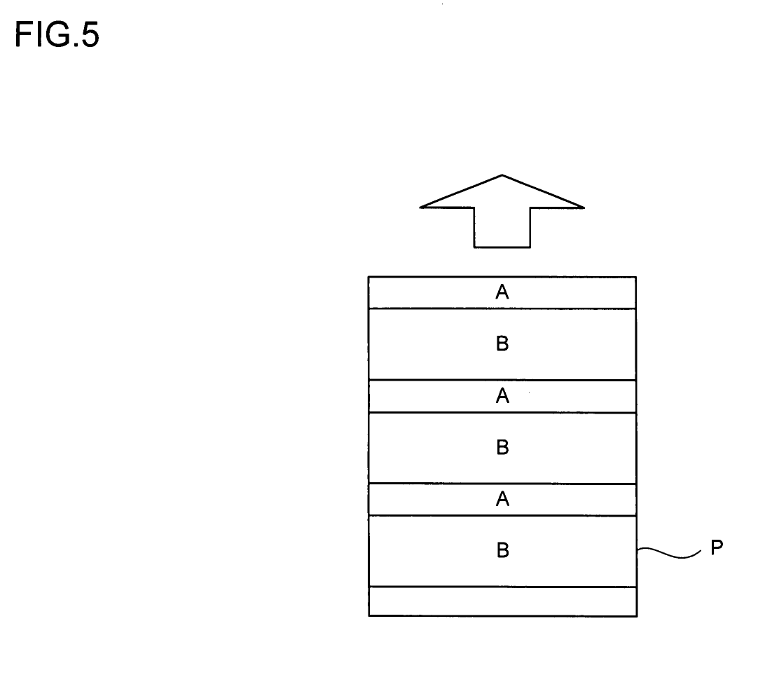

Thus, as shown in FIG. 5, on the recording paper P are formed the high-frequency region A where image forming is performed with the frequency of the AC component of the developing bias voltage increased and a low frequency region B where image forming is performed with the frequency of the AC component of the developing bias voltage decreased.

In the case of the low-definition mode, all image data is read at step #20, and then the process proceeds to step #17. At step #17, the frequency of the AC component of the developing bias voltage applied to the developing roller 38 is set to, for example, 1600 Hz. Then, at step #18, development and printing are performed based on the set frequency of the AC component of the developing bias voltage, and then the process proceeds to step #19, after which the process is finished.

According to this embodiment, the frequency of the AC component of the developing bias voltage applied to the developing roller 38 is varied according to image data. This makes it possible to prevent concentration variation occurring in the case of a non-character image, where concentration variation is visually noticeable, by setting the frequency of the AC component of the developing bias voltage high to stabilize the charge amount of the developer. In the case of a character image, where concentration variation is hardly noticeable visually, the amount of heat generated by an electronic component for applying a high frequency voltage can be reduced by setting the frequency of the AC component of the developing bias voltage low. This helps reduce the total amount of heat generated by electronic components in image forming operation. This eliminates the need to use an electronic component having a high rated frequency, and thus eliminates the need to provide cooling means such as a heat sink and a fan. Thus, concentration variation occurring in an image can be prevented without cost increase or size increase.

Furthermore, since the high-frequency region A and the low-frequency region B are formed when image forming is performed in the high-definition mode, and the frequency of the AC component of the developing bias voltage is decreased when image forming is performed in the low-definition mode, the amount of heat generation can be reduced in the low-definition mode, which is not required to offer a high image quality. Thus, it is possible to prevent concentration variation and further reduce the amount of heat generation.

In this embodiment, the high-frequency region A and the low-frequency region B are separately formed depending on whether an image is a non-character image or a character image, but they may be formed based on different image classification. For example, a non-character image including a halftone may be the high-frequency region A, and a non-character image including no halftone and a character image may be the low-frequency region B.

Also, a color image may be the high-frequency region A, and a monochrome image may be the low-frequency region B. That is, an image in which concentration variation is visually noticeable may be the high-frequency region A, and an image in which concentration variation is hardly noticeable visually may be the low-frequency region B.

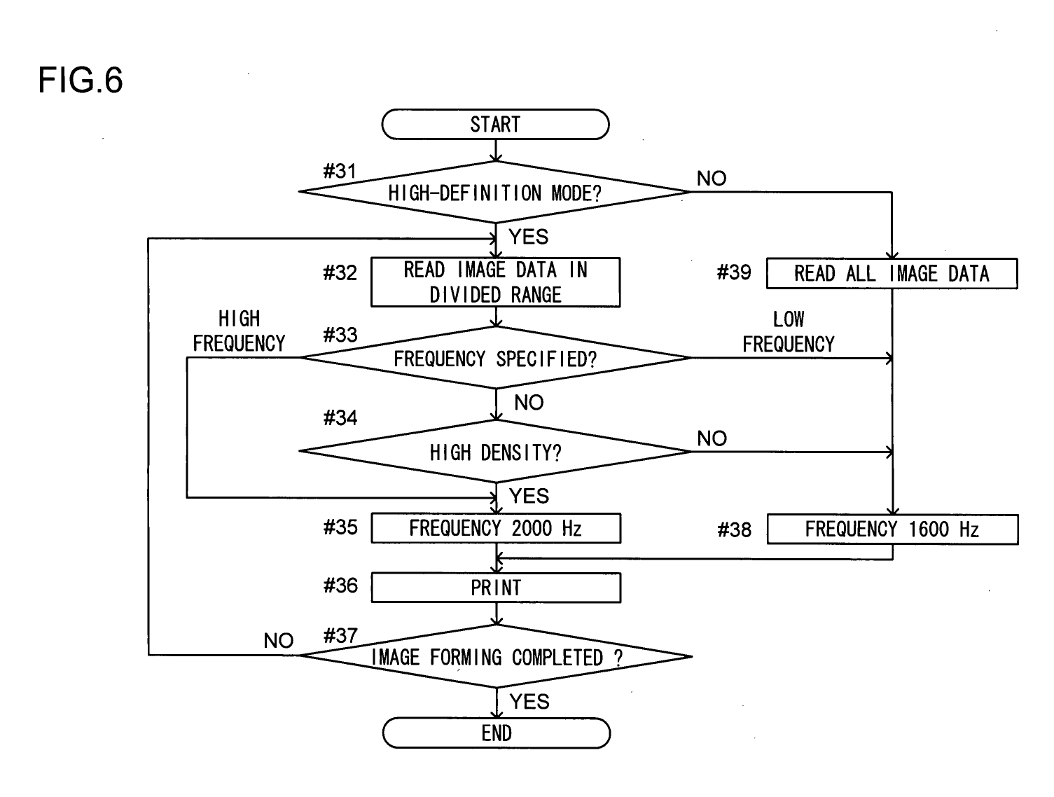

Next, description will be given of a second embodiment. This embodiment is the same in structure as the first embodiment, but the image forming units 3M, 3C, 3Y, and 3K operate in a manner different from in the first embodiment. FIG. 6 is a flow chart showing how the image forming units 3M, 3C, 3Y, and 3K of this embodiment operate.

As in the first embodiment, the image forming apparatus is instructed by the personal computer 94 to operate in the high-definition mode or in the low-definition mode. In addition, each one of the divided ranges into which an image forming range is divided can be specified by the personal computer 94 either as the high-frequency region A or as the low-frequency region B. Each of the divided ranges is one of the pages into which the whole image-forming range is divided, one of a plurality of ranges into which a page is divided, and the like.

When a printing instruction is given by the personal computer 94, it is checked at step #31 whether or not the printing should be performed in the high-definition mode. In the case of printing in the low-definition mode, the process proceeds to step #39. In the case of printing in the low-definition mode, the process proceeds to step #32, where the image data fed from the personal computer 94 is read for each divided range described above on a one-by-one basis.

At step #33, it is checked whether or not the divided range for which the image data has been read is specified either as the high-frequency region A or as the high-frequency region B. When the divided range is specified neither as the high-frequency region A nor as the low-frequency region B, the process proceeds to step #34. When the divided range is specified as the high-frequency region A, the process proceeds to step #35. When the divided range is specified as the low-frequency region B, the process proceeds to step #38.

At step #34, it is checked whether or not the density of the read image data is higher than a predetermined density. When the density is higher than the predetermined density, the process proceeds to step #35, and when the density is lower than the predetermined density, the process proceeds to step #38. For example, in the case where toner is transferred with respect to not less than 50% of all the dots in the divided range, the process proceeds to step #35, and in the case where toner is transferred with respect to less than 50% of all the dots in the divided range, the process proceeds to step #38.

At step #35, the frequency of the AC component of the developing bias voltage applied to the developing roller 38 is set to, for example, 2000 Hz. Thus, in the case where the divided range is specified as the high-frequency region A or in the case of an image of high density, a high-frequency developing bias voltage is applied to the developing roller 38. At step #38, the frequency of the AC component of the developing bias voltage applied to the developing roller 38 is set to, for example, 1600 Hz. Thus, in the case where the divided range is specified as the low-frequency region B and in the case where the divided range has low image density, a low-frequency developing bias voltage is applied to the developing roller 38.

At step #36, development is performed according to the set frequency of the AC component of the developing bias voltage, and image printing is performed. At step #37, it is checked whether or not image forming of all the divided ranges instructed by the personal computer 94 has been completed. When image forming of all the divided ranges has not been completed, steps #32 to #38 are repeatedly performed. When image forming of all the divided ranges has been completed, the processing by the image forming units 3M, 3C, 3Y, and 3K is finished.

In the case of the low-definition mode, all the image data is read at step #39, and the process proceeds to step #38. At step #38, the frequency of the AC component of the developing bias voltage applied to the developing roller 38 is set to, for example, 1600 Hz. Then, at step #36, development and printing are performed according to the set frequency of the AC component of the developing bias voltage, and then, the process proceeds to step #37, after which the process is finished.

According to this embodiment, as in the first embodiment, the frequency of the AC component of the developing bias voltage applied to the developing roller 38 can be varied for each divided range. This makes it possible, in the case where a predetermined divided range includes an image of high density, where concentration variation is visually noticeable, to prevent concentration variation from occurring by increasing the frequency of the AC component of the developing bias voltage so as to stabilize the charge amount of the developer. In addition, it is possible, in the case where the divided range has low density, where concentration variation is hardly noticeable visually, to reduce the amount of heat generated by the electronic components for applying a high-frequency voltage by decreasing the frequency of the AC component of the developing bias voltage.

The user may be allowed to set the high-frequency region A and the low-frequency region B with respect to any image data. This makes it possible to securely prevent concentration variation occurring in a divided range as the user desires. This makes the image forming apparatus 1 even more user-friendly.

In this embodiment, the high-frequency region A and the low-frequency region B are separately formed according to whether the image in the divided range is a high-density image or a low-density image, but they may be formed separately based on a different image classification.

For example, a divided range the image in which includes a non-character image may be specified as the high-frequency region A, and a divided range the image in which includes no non-character image may be specified as the low-frequency region B. Also, a divided range the image in which includes a halftone non-character image may be specified as the high-frequency region A, and a divided range the image in which includes no halftone non-character image may be specified as the low-frequency region B.

Also, a divided range the image in which includes a color image may be specified as the high-frequency region A, and a divided range the image in which includes no color image may be specified as the low-frequency region B. That is, a divided range including an image in which concentration variation is visually noticeable may be specified as the high-frequency region A, and a divided range including no image in which concentration variation is visually noticeable may be specified as the low-frequency region B.

In the first and second embodiments, the image forming apparatus 1 is a color printer; however, it may be other image forming apparatuses such as monochrome printers, copiers, and facsimiles. That is, the present invention can offer the same effect in image forming apparatuses where an electrostatic latent image is visualized by a developer carried on the developing roller 38 serving as the developer carrier.

The present invention is applicable in an image forming apparatus where an electrostatic latent image is visualized with a developer carried on a developer carrier.

What is claimed is:

1. An image forming apparatus, comprising:
a photoconductive drum on which an electrostatic latent image is formed; and
a developer carrier that is arranged adjacent to the photoconductive drum, that is allowed, by a developing bias voltage composed of a DC component and an AC component applied thereto, to carry a developer thereon with which the electrostatic latent image is visualized and is formed as an image on recording paper, and that forms, in an image on the recording paper, a high-frequency region where image forming is performed with a frequency of the AC component of the bias voltage increased according to image data and a low-frequency region where image forming is performed with the frequency of the AC component of the bias voltage decreased according to image data.

2. The image forming apparatus of claim 1, further comprising a plurality of image quality modes of different degrees of definition,
wherein
the high-frequency region and the low-frequency region are formed in a high-definition image quality mode, and
the frequency of the AC component of the developing bias voltage in a low-definition image quality mode is set low regardless of the image data.

3. The image forming apparatus of claim 1,
wherein
an image in the high-frequency region is a non-character image and an image in the low-frequency region is a character image.

4. The image forming apparatus of claim 1,
wherein
an image in the high-frequency region is a non-character image that includes a halftone, and an image in the low-frequency region is a non-character image that includes no halftone.

5. The image forming apparatus of claim 1,
wherein
an image in the high-frequency region is a color image, and an image in the low-frequency region is a monochrome image.

6. The image forming apparatus of claim 1,
wherein
the image data is recognized such that each of divided ranges into which an image forming range is divided is recognized one by one, and
each divided range is variable between the high-frequency region and the low-frequency region according to a recognition result.

7. The image forming apparatus of claim 6,
wherein
density in an image is high in the high-frequency region and low in the low-frequency region.

8. The image forming apparatus of claim 6,
wherein
an image in the high-frequency region includes a non-character image and
an image in the low-frequency region includes no non-character image.

9. The image forming apparatus of claim 6,
wherein
an image in the high-frequency region includes a halftone non-character image and an image in the low-frequency region includes no halftone non-character image.

10. The image forming apparatus of claim 6,
wherein
an image in the high-frequency region includes a color image and an image in the low-frequency region includes no color image.

11. The image forming apparatus of claim 6,
wherein
the high-frequency region and the low-frequency region can be set by a user.

12. The image forming apparatus of claim 1,
wherein
the developer is mono-component nonmagnetic toner.
